(19) United States
(12) Patent Application Publication
(10) Pub. No.: US 2010/0315002 A1
(43) Pub. Date: Dec. 16, 2010

(54) HALOGEN INCANDESCENT LAMP COMPRISING AN INFRARED REFLECTIVE COATING

(75) Inventor: Hans-Joachim Schmidt, Ingolstadt (DE)

Correspondence Address: Viering, Jentschura & Partner - OSR, 3770 Highland Ave., Suite 203, Manhattan Beach, CA, 90266, US

(73) Assignee: OSRAM Gesellschaft mit beschraenkter Haftung, Muenchen (DE)

(21) Appl. No.: 12/808,692

(22) PCT Filed: Dec. 18, 2008
(86) PCT No.: PCT/EP2008/067838

§ 371 Date: Jun. 17, 2010

(30) Foreign Application Priority Data
Dec. 18, 2007 (DE) 20 2007 017 598.1

(51) Int. Cl. H01K 1/32; H01K 1/62

(52) U.S. Cl. 315/70; 313/113

(57) ABSTRACT

A halogen incandescent lamp is provided with a rotationally symmetrical bulb, which has a longitudinal axis and in which at least part of a surface of the bulb is provided with a coating which reflects infrared radiation, a coiled light-emitting element being arranged axially in the bulb, the bulb being provided with an infrared reflective coating layer, wherein the length L and the diameter D of the coiled light-emitting element are at a ratio of at least 6:1 with respect to one another, and wherein the bulb is in the form of an ellipsoid, the ends of the light-emitting element lying substantially at the two foci of the ellipse spanning the ellipsoid in the form of a solid of revolution, with an eccentricity in the range of from 0.5 to 0.7.

### TECHNICAL FIELD

The invention is based on a halogen incandescent lamp with an IRC coating on the bulb. Of particular interest here are low-voltage lamps (LV lamps) which are operated at a voltage of at most 48 V, preferable from 6 to 18 V, or else medium-voltage and high-voltage lamps which are operated at a voltage of normally from 80 to 250 V.

### PRIOR ART

EP-A 765 528 describes a halogen incandescent lamp using IRC technology. FIG. 2 discussed therein shows a lamp using LV technology, and FIG. 4 shows a lamp using HV technology. In that case, an ellipsoidal barrel-shaped body is used as the bulb and is coated with IRC.

A lamp using HV technology, based on an LV burner and associated transformer, is known from DE 83 29 164 U.

### DESCRIPTION OF THE INVENTION

The object of the present invention is to specify a halogen incandescent lamp with an IRC coating which is characterized by the highest possible efficiency.

This object is achieved by the characterizing features of claim 1.

Particularly advantageous configurations are given in the dependent claims.

According to the invention, the halogen incandescent lamp is characterized by the combination of two features: the especially developed filament has a length L and a diameter D, where L:D≧6. In particular, L:D should be in the range of from 9 to 11. The bulb has, in longitudinal section, an elliptical contour with a critical dependence on the eccentricity of the selected ellipse. According to the invention, the eccentricity should be selected to be ε=0.5 to 0.7.

Halogen incandescent lamps with an infrared-reflective bulb coating (IRC lamps) for low and medium voltages of up to 140 V are already known. Measures for improving the efficiency of said lamps have until now concentrated on the optimization of the layer systems. However, the text which follows intends to show that, in contrast to the situation with conventional lamps, the lighting-engineering properties of an IRC-coated lamp depend quite considerably on details of the design and also on the absolute size of the lamp bulb.

Any halogen lamp with an ellipsoidal bulb requires a feed line from the filament to the pinch seal. In addition, however, a neck is required in the vicinity of the pinch seal, in particular implemented in the form of a rolled-in portion at the transition to the pinch seal. In addition, an exhaust tip has until now been required.

Both elements interfere with the transmission of the utilized flux and reduce the proportion of the bulb surface which is available for back-reflection onto the filament by means of the IRC layer. Since the two elements make up a considerable part of the bulb surface, this is a substantial amount of disruption.

In the regions affected by the disruption close to the neck and the exhaust tip, the transmission is restricted because the light is emitted, for example through the exhaust tip or indirectly via the pinch seal or is absorbed as a result of a malfunction of the IRC layer or is reflected back into the bulb. Notable IR reflection back onto the filament is impossible in these regions.

A further undesirable effect of the bulb shape is color fringing which is often perceptible in the case of coated lamps. In the ideal case, an IRC layer should be invisible to the eye. If color fringing occurs to a considerable extent, this means a light-absorbing and therefore efficiency-reducing malfunction of the layer in this region.

This malfunction occurs to an increased extent in the region of a marked curvature of the bulb because the desired thickness of the IRC layers applied cannot be controlled to a sufficiently accurate extent here as a result of the large angle between the surface normal and the direction from which the coating has been applied to the bulb surface.

In addition to the abovementioned effects, there are increased manufacturing-related defects in the bulb surface in the region of the exhaust tip and the bulb neck. As a result, the application of the IRC layers is additionally made more difficult and the function of the IRC layers is additionally impaired.

In the region of the exhaust tip, there is primarily the problem of quartz smoke which is produced when the exhaust tip is fused. Although this quartz smoke is removed prior to the application of the IRC coating, for example by means of polishing, as a consequence a certain degree of roughness of the surface remains in this region.

In the region of the bulb neck, fine grooves are often produced as a result of the rolling-in process during the manufacture of the neck. The disruption of the function of the IRC layers as a result of the exhaust tip and the rolled-in portion relates overall to a much larger area than that taken up by the two elements, namely the neck and the exhaust tip.

An estimation of the region which is undisrupted and which results based on the center point of the bulb, expressed as a solid angle, shows that only approximately 70%, in the case of LV lamps with very small and virtually spherical bulbs, and only approximately 80%, in the case of MV and HV lamps with relatively small ellipsoidal bulbs, of the full solid angle of 4 π steradian can be used for undisrupted light transmission and back-reflection by the IRC layer.

In the prior art, the transmission is restricted in the disrupted regions close to the neck and the exhaust tip because the light is emitted, for example, through the exhaust tip or indirectly via the pinch seal or is absorbed as a result of a malfunction of the IRC layer or is reflected back into the bulb. Notable IR reflection back onto the filament is impossible in these regions.

The extent of the disrupted regions is dependent purely on the manufacturing process and is independent of other dimensions, for example the length and the diameter of the lamp bulb. It is therefore possible to achieve a considerable increase in efficiency by enlarging the undisrupted surface merely as a result of geometric dimensions of the bulb which are selected in a targeted manner to be as large as possible.

A lamp bulb which is provided in a targeted manner with large dimensions, in contrast to the prior art, additionally has an advantage in terms of general efficiency because the dimensions of a lot of irregularities, for example striations, inclusions or bubbles in the glass or defects in the IRC layer are not dependent on the dimensions of the lamp bulb. A large lamp bulb therefore always provides a more favorable ratio of intact to disrupted area than a small bulb.

A lamp bulb with large dimensions also has the advantage of low thermal loading of the IRC layer, with the result that a temperature-dependent reduction in the efficiency as a result of aging of the layer, for example formation of cracks, over the course of the life can be prevented.

The losses at both poles of the lamp body formed by the exhaust tip and the neck can additionally be reduced by the choice of an axially arranged light-emitting element which is as elongated as possible and is as thin as possible because, in the case of such a light-emitting element, virtually only lateral emission into the undisrupted bulb regions takes place. A short incandescent filament with a relatively large diameter in contrast to this has a virtually spherical light distribution element, i.e. emits uniformly into the favorable and unfavorable bulb regions.

When comparing the bulb contours it is furthermore apparent that an MV lamp, and even more so an HV lamp, has a rearward opening with much larger dimensions and therefore a larger neck than an LV lamp. This is necessary in order to ensure a sufficient gap between the power supply lines which are led out parallel from the neck, with the result that the formation of an are is prevented. It is clear from this that a bulb shape which is optimized in terms of efficiency is possible primarily when using a low voltage for supplying the lamp, but is also possible in the case of MV and HV lamps given suitable dimensioning of the bulb.

The use of a low voltage furthermore has the advantage that, owing to the relatively high wire cross sections, an incandescent filament which is mechanically stable without any further auxiliary means and which has the desired dimensions can be realized.

It is apparent from the observations above that a very high overall efficiency and efficiency in the case of a halogen incandescent lamp can be achieved if, entirely intentionally, a low-voltage technology is used, with an elongated ellipsoidal bulb and an elongate light-emitting element being used, in contrast to the prior art. In this case, the eccentricity of the bulb ε should be in the range of from 0.5 to 0.7, and the ratio of the length and diameter L:D of the light-emitting element should be selected in the region of above 6:1.

The possible improvement in efficiency can be made plausible just by extrapolating the data of a krypton-filled test lamp which has substantially the desired dimensions for the bulb and the filament but is designed for a voltage of 120 V. Thus, a luminous efficacy of 31.9 lm/W corresponding to an 86% efficiency gain or 7% heating resistor growth of the filament could be achieved, with the life being 1162 h.

Specifically, an increase in efficiency, for example, can be estimated as follows. It is assumed that the diameter of the bulb neck and therefore of the disrupted bulb region towards the pinch seal in the case of an LV lamp (12 V) can be reduced to half the value of a 120 V lamp because there is no risk of arc formation. This results in a free radiation range of 144° in comparison with 121° for a 120 V lamp. This corresponds to a solid angle which is greater by 12% and, in the case of a Lambert-radiating cylinder as the light-emitting element, this corresponds to an overall radiant flux [A] which is 7% higher through the undisrupted bulb region.

This improvement has a full effect on the radiation reflected back by the IRC layer onto the filament and thus on the heating resistor growth HRG, which is increased starting from 7% in the case of the 120 V lamp to HRG=1.07*7%=7.5% [B].

A power consumption of the filament of, for example, 43 W, uncoated, therefore returns to 40 W, namely 43 W/1.075 [C].

In order to calculate the luminous flux, the luminous efficacy of the 120 V lamp which has been converted for 2000 h, is used, i.e. 29.3 lm/W at 2000 h=0.92*31.9 lm/W with a life of 1162 h [D].

Since, as is known from experience, there is an efficiency advantage of approximately 6% in favor of the 12 V lamp between comparable 120 V and 12 V lamps, the following value results

31.1 lm/W at 12 V=1.06*29.3 lm/W at 120 V [E]

If the disruption-free region has a light transmission which is 50% higher than the disrupted region in the vicinity of the neck and the exhaust tip, owing to [A] and [C] the directly emitted luminous flux is increased by 3.5%, which results in a luminous flux of

1288 lm=1.035*31.1 lm/W*40 W. [F]:

The luminous efficacy is then

32.2 lm/W with a life of 2000 h. [G]

By using xenon as the main constituent in the fill gas instead of a krypton fill, the life is increased on average by approximately 50%, with the result that the proposed lamp achieves, in terms of order of magnitude, approximately

32.2 lm/W with a life of 3000 h. [H]

Assuming a 95% overall efficiency in the case of an electronic transformer, a system voltage lamp based on an LV lamp according to the invention as the burner can reach a system luminous efficacy of

30.6 lm/W=1288 lm/(40 W/0.95) [I]

owing to [C]. That is to say that a system voltage lamp with an electronic transformer can therefore be realized which produces the luminous flux of a 100 W general service lamp with a power consumption of 42 W.

For the implementation both as an LV lamp and as an HV lamp, it is advantageous if the lamp vessel is a closed ellipsoid and not a barrel-shaped body. The semi-major axis of the ellipsoid should be (in the undisrupted, ideal case) at least 9.5 mm, and the semi-minor axis at least 7.5 mm. The largest outer diameter of the bulb should correspondingly be at least 15 mm, while until now conventional LV lamps have had a maximum outer diameter of approximately 12 mm. The exhaust tip and the neck region are configured in such a way that their basic diameter is at most 6 mm.

The light-emitting element is arranged axially and extends in a region between the two foci of the ellipsoid. Owing to its dimensions for L (length of the light-emitting element) and D (outer diameter of the light-emitting element), it can be assumed to be virtually filiform. This dimensioning is in stark contrast to the prior art, which has generally selected a barrel-shaped body for the ellipsoid and in which the light-emitting element must be assumed not to be filiform, but to be in the form of a cylinder body.

### BRIEF DESCRIPTION OF THE DRAWINGS

The invention will be explained in more detail below with reference to a plurality of exemplary embodiments. In the figures:

FIG. 1 shows a halogen incandescent lamp in the form of a basic illustration;

FIG. 2 shows an illustration of the undisrupted and disrupted bulb regions as a schematic;

FIG. 3 shows a system voltage lamp on the basis of the proposed LV IRC burner and an associated transformer;

FIG. 4 shows a cross section through a pinch seal with an integrated exhaust hole;

FIG. 5 shows a bulb with a shaped first end.

### PREFERRED EMBODIMENT OF THE INVENTION

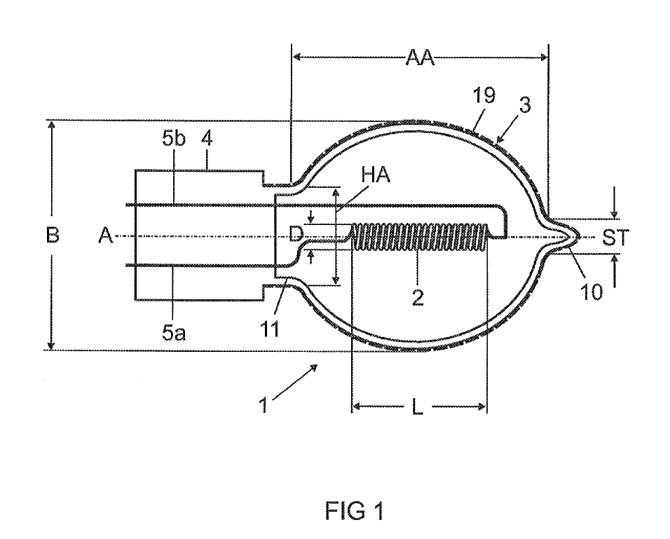

One exemplary embodiment of an LV halogen incandescent lamp 1 is shown in FIG. 1. It has a light-emitting element 2 with a single coil and an elongated bulb 3, which is equipped with a longitudinal axis A and ends in a pinch seal 4. Two power supply lines 5a, 5b are passed through the pinch seal, possibly via foils, out of the interior of the bulb. The power supply lines 5 hold the axially arranged light-emitting element 2. The bulb 3 is in the form of an ellipsoid with an eccentricity of ε=0.6.

The bulb 3 has an exhaust tip 10 and, at the opposite end of the bulb, a neck 11, which ends in the pinch seal 4. The light-emitting element is held in the bulb by the two power supply lines in such a way that a short power supply line 5a is passed approximately axially with respect to the pinch seal and a second power supply line 5b is passed back from that end of the light-emitting element which is remote from the pinch seal toward the pinch seal at a distance from the axis. AA in this case denotes double the value of the semi-major axis, in this case selected as 20 mm. B denotes double the value of the semi-minor axis, in this case selected as 16 mm. The bulb is IRC-coated (19) on the outside or else on the inside, as is known per se. The length L of the light-emitting element 2 is 12 mm, and its outer diameter D is 1.2 mm.

The region in the vicinity of the exhaust tip which is susceptible to disruption is denoted by ST, and its basic diameter should not exceed 6 mm transversely with respect to the longitudinal axis. The region in the vicinity of the neck which is susceptible to disruption is denoted by HA. Its basic diameter transversely with respect to the longitudinal axis should not exceed 6 mm either.

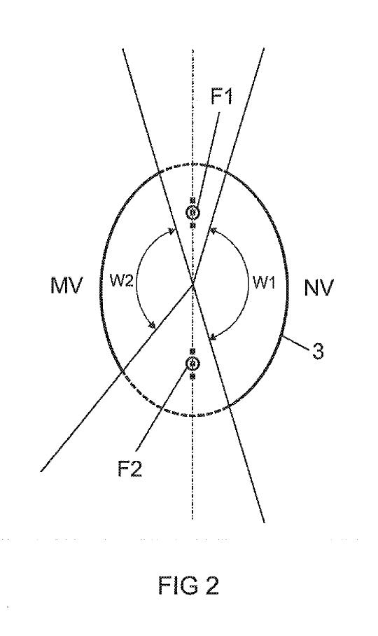

In FIG. 2, the geometry of the bulb 3 is illustrated schematically. A typical opening angle W1 for the undisrupted and therefore fully usable region of the bulb is 144°.

A specific exemplary embodiment is a lamp with a pinch seal at one end. The length A=2a of the ellipsoidal bulb is 15-30 mm, and the maximum diameter B=2b is 15-25 mm, if a and b are the semi-axes of the basic ellipse. The outer diameter C of the rolled-in neck is at most 8 mm. The axis of the incandescent filament coincides with the major axis, indicated by dash-dotted lines, of the ellipsoidal bulb, where the ends of the light-emitting element are located in the region of the ellipse foci (not illustrated).

In contrast to the geometrical proportions which have until now been conventional primarily in low-voltage IRC lamps, the ratio of length L and diameter D in the case of the light-emitting element of the filament should be at least 6:1, where values in the region of around 10:1 are preferred, in particular 9:1 to 11:1. This ensures that the emission takes place primarily laterally into the undisrupted bulb regions.

The incandescent filament is made from a high-melting material, for example a tungsten wire, whose diameter is selected to be between 10 and 300 μm for implementing various power stages at from LV to HV. In the case of HV, this is generally in the range of from 10 to 50 μm, and in the case of LV this is rather in the range of from 100 to 300 μm. In the case of MV, the diameter is in between these values. The lamp vessel is preferably made from quartz glass, and therefore molybdenum foils (not illustrated) are often used in the pinch seal for sealing the power supply lines.

An elongated, ellipsoidal bulb, as has already been explained, has advantages when applying the coating in comparison with a more spherical shape. On the other hand, a very pointed and elongate shape with high eccentricity given realistic diameters and filament lengths does not provide enough space in the region of the filament ends, i.e. the distance between the filament and the bulb in this region brings about thermal problems and the frame which is required for suspending the filament can only be accommodated with difficulty. The best compromise between these contradictory requirements is provided by an elliptical contour with an eccentricity of

0.5≦ε≦0.7.

In the case of a light-emitting element which runs from focus to focus, ε at the same time also corresponds to the ratio of the filament length to the bulb length.

In addition to the general advantage of increased luminous efficacy, the proposed solution is characterized by its pronounced lateral emission of light owing to the elongate light-emitting element. This results in a particular suitability for system voltage lamps with a screw-type or bayonet-type base and electronic control gear. In the case of such lamps, the control gear fitted between the base and the low-voltage burner generally has a much larger diameter than the lamp base, i.e. shades the light coming from the burner in this region. As a result of the preferably lateral emission of the proposed solution, the resultant losses are avoided.

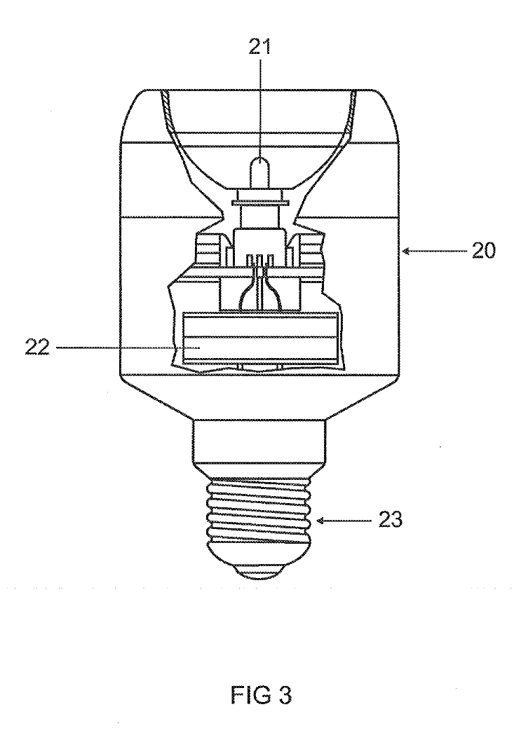

FIG. 3 shows a schematic of a typical HV lamp 20 with a screw-type base 23 on the basis of an LV burner 21 and an associated transformer 22 integrated in the lamp.

Particularly high efficiencies can be achieved with halogen incandescent lamps for the low-voltage range for operating voltages of 6-48 V. The lamp has an axial incandescent filament with a cylindrical enveloping contour and an ellipsoidal bulb, which has been provided with an infrared-reflecting layer (IRC layer).

In contrast to the known low-voltage IRC lamps, the incandescent filament is designed to be very elongated and to have a small diameter. As a result, the ellipsoidal bulb can be provided with an elongate shape with a slight surface curvature and a relatively large diameter, as a result of which the coating of said bulb is facilitated and the long term stability of the layer is improved.

In contrast to the known medium-voltage IRC lamps, a much smaller opening for passing through the power supply is required owing to the relatively low supply voltage. This increases the bulb area which can be used for reflection of infrared back onto the filament, which improves the overall efficiency quite considerably. Owing to its configuration, the proposed lamp is far better suited as a built-in lamp, conventionally referred to as a burner, for use in system voltage lamps (high-voltage and medium-voltage systems) with electronic control gear than conventional low-voltage burners. Such system voltage lamps can of course also be integrated in luminaires. The basic design is similar to that described in DE 83 29 164 U.

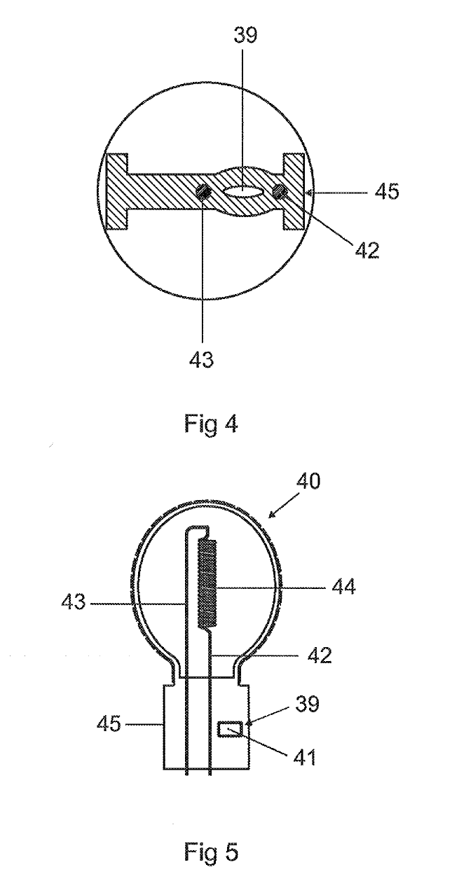

In a particularly preferred embodiment, the bulb does not have an exhaust hole at all at its first end, but is rounded off following the ellipsoid, wherein the exhaust hole is integrated in the pinch seal. Such a basic design is known from WO 2007/110320. FIG. 4 shows such a pinch seal 45 in cross section, with the exhaust hole 39 being illustrated as being open.

FIG. 5 shows a lamp with the shaped first end 40 matching the ellipsoid, wherein an exhaust hole 39 is integrated laterally in the pinch seal. Said exhaust hole is sealed there with a seal 41, in a similar manner to that described in WO 2007/110320. The power supply lines 42 and 43 are in this case passed outward through the pinch seal 45 decentrally from the light-emitting element 44.

1. A halogen incandescent lamp with a rotationally symmetrical bulb, which has a longitudinal axis and in which at least part of a surface of the bulb is provided with a coating which reflects infrared radiation, a coiled light-emitting element being arranged axially in the bulb, the bulb being provided with an infrared reflective coating layer, wherein the length L and the diameter D of the coiled light-emitting element are at a ratio of at least 6:1 with respect to one another, and wherein the bulb is in the form of an ellipsoid, the ends of the light-emitting element lying substantially at the two foci of the ellipse spanning the ellipsoid in the form of a solid of revolution, with an eccentricity in the range of from 0.5 to 0.7.

2. The halogen incandescent lamp as claimed in claim 1, wherein the lamp is a low-voltage lamp, in which the light-emitting element is designed for a voltage of a maximum of 48 V.

3. The halogen incandescent lamp as claimed in claim 2, wherein the light-emitting element is designed for a voltage in the range of from 6 to 18 V.

4. The halogen incandescent lamp as claimed in claim 1, wherein the lamp is an MV or HV lamp with a light-emitting element which is designed for a voltage of from 80 to 250 V.

5. The halogen incandescent lamp as claimed in claim 1, wherein L:D is in the range of from 9 to 11.

6. The halogen incandescent lamp as claimed in claim 1, wherein the semi-major axis of the ellipse is at least 9.5 mm long.

7. The halogen incandescent lamp as claimed in claim 1, wherein the semi-minor axis of the ellipse is at least 7.5 mm long.

8. The halogen incandescent lamp as claimed in claim 1, wherein the coiled light-emitting element has a length L of from 10 to 15 mm.

9. The halogen incandescent lamp as claimed in claim 1, wherein the coiled light-emitting element has an outer diameter of from 0.9 to 1.7 mm.

10. The halogen incandescent lamp as claimed in claim 1, wherein the coiled light-emitting element comprises tungsten wire with a diameter d of between 10 and 300 μm.

11. The halogen incandescent lamp as claimed in claim 1, wherein the bulb has an exhaust tip at a first end of the longitudinal axis, the dimension of the exhaust tip as a disruption zone for the infrared reflective coating is at most 8 mm, transversely with respect to the longitudinal axis.

12. The halogen incandescent lamp as claimed in claim 1, wherein the bulb is rounded off at its first end following the ellipsoid, the exhaust hole being integrated in the pinch seal.

13. The halogen incandescent lamp as claimed in claim 1, wherein the bulb has a neck at a second end of the longitudinal axis, the dimension of the neck as a disruption zone for the infrared reflective coating is at most 8 mm transversely with respect to the longitudinal axis for an LV lamp.

14. A lamp for operation on a system voltage, the lamp comprising a burner for operation on a low voltage in the range of from 6 to 48 V; and a transformer, wherein the burner comprises a halogen incandescent lamp with a rotationally symmetrical bulb, which has a longitudinal axis and in which at least part of a surface of the bulb is provided with a coating which reflects infrared radiation, a coiled light-emitting element being arranged axially in the bulb, the bulb being provided with an infrared reflective coating layer, wherein the length L and the diameter D of the coiled light-emitting element are at a ratio of at least 6:1 with respect to one another, and wherein the bulb is in the form of an ellipsoid, the ends of the light-emitting element lying substantially at the two foci of the ellipse spanning the ellipsoid in the form of a solid of revolution, with an eccentricity in the range of from 0.5 to 0.7; wherein the lamp is a low-voltage lamp, in which the light-emitting element is designed for a voltage of a maximum of 48 V.

15. The halogen incandescent lamp as claimed in claim 10,
wherein the coiled light-emitting element comprises tungsten wire with a diameter d=10 to 50 μm for an HV lamp and a diameter D=100 to 300 μm for a low-voltage lamp.

16. The halogen incandescent lamp as claimed in claim 11,
wherein the bulb has an exhaust tip at a first end of the longitudinal axis, the dimension of the exhaust tip as a disruption zone for the infrared reflective coating is at most 6 mm, transversely with respect to the longitudinal axis.

17. The halogen incandescent lamp as claimed in claim 13,
wherein the bulb has a neck at a second end of the longitudinal axis, the dimension of the neck as a disruption zone for the infrared reflective coating is, transversely with respect to the longitudinal axis for LV lamps, in the range from 4 to 6 mm.

18. A luminaire for operation on a system voltage, the luminaire comprising a burner for operation on a low voltage in the range of from 6 to 48 V; and a transformer, wherein the burner comprises a halogen incandescent lamp with a rotationally symmetrical bulb, which has a longitudinal axis and in which at least part of a surface of the bulb is provided with a coating which reflects infrared radiation, a coiled light-emitting element being arranged axially in the bulb, the bulb being provided with an infrared reflective coating layer, wherein the length L and the diameter D of the coiled light-emitting element are at a ratio of at least 6:1 with respect to one another, and wherein the bulb is in the form of an ellipsoid, the ends of the light-emitting element lying substantially at the two foci of the ellipse spanning the ellipsoid in the form of a solid of revolution, with an eccentricity in the range of from 0.5 to 0.7; wherein the lamp is a low-voltage lamp, in which the light-emitting element is designed for a voltage of a maximum of 48 V.
